(19) United States
(12) Patent Application Publication
(10) Pub. No.: US 2011/0278759 A1
(43) Pub. Date: Nov. 17, 2011

(54) Anti-Delamination Feature For Double Injection Mold Parts

(75) Inventors: Bk SOHN, Kyeonggi-do (KR); Kt LIM, Kyeonggi-Do (KR)

(73) Assignee: MOTOROLA, INC., Schaumburg, IL (US)

(21) Appl. No.: 12/781,122

(22) Filed: May 17, 2010

(51) Int. Cl. B29C 45/14; B29C 45/16

(52) U.S. Cl. 264/250; 425/542

(57) ABSTRACT

An effective economical anti-delamination feature 100 and process 102 for double injected molding is provided to mold attractive high quality products 104, such as, but not limited to, grommets 106 for use in electronic communications devices 108. In the process, after a first shot 114 is injected into a double injection mold 110, an undercut 116 comprising a delamination feature is formed in the double injection mold by tool compression or partial heating, before injecting a second shot 128 into the double injection mold.

### BACKGROUND OF THE INVENTION

1. Field of the Disclosure

This invention relates to double injection molding, and more particularly, to an anti-delamination feature and process for producing double injection molded parts.

2. Background Art

Double injection molding provides for use of different materials and/or colors in the molded parts allows more choices of finishes to produce more attractive and a greater variety of molded parts. A significant problem in double injection molding is that second (2^{nd}) shot material can get easily delaminated from the first (1^{st}) shot material in the double injection molded parts in the user's hands over time. In an effort to solve this problem, some features can be added to increase the mating surface area between the 1^{st} and 2^{nd} shots to reduce the chance of delamination. The features can be formed and molded copying the core shape. This technique, however, still creates a significant chance of delamination where the 1^{st} and 2^{nd} shots of injection molded arts are easily delamination over time and it is, therefore, not a permanent solution.

For prevention of delamination, conventional features can be added to the 1^{st} shot to increase the area of mating surface. It can reduce the chance of delamination but cannot completely insure that there will be no delamination defect in field.

It is, therefore, desirable to provide an anti-delamination feature and process for producing double injection molded parts, which overcomes most, if not all, of the preceding problems.

### SUMMARY OF THE INVENTION

An improved anti-delamination feature and process for producing double injection molded parts is provided to prevent delamination of molded parts. Advantageously, the anti-delamination feature and process produces attractive double injection molded parts and is economical, efficient and effective.

In the anti-delamination feature and process for producing double injection molded parts, a number of round poles can be molded at the 1^{st} shot, at a location proud from the parting line dependent on the design. These poles can be compressed down to the parting by a clamping force at the second shot. Those poles can compress between the 1^{st} and 2^{nd} shots to be shaped like a rivet and the undercuts of rivet poles can prevent the second shot from delamination.

A number or undercut shapes will fundamentally prevent the delamination. Even if a double injection molded part has a very thin total thickness with a very small amount of mating surface area, the undercut shape can significantly reduce the chance of delamination in use.

The novel method can provide for trapping a second shot of rubber or other material so that it does not peel away. The approach is similar to making a rivet to stake the rubber to the underlying plastic part. The “rivet” head is formed by the tooling when it is closed to make the rubber injections shot. This idea is specifically for the USB grommets but can be applied to any multiple injection material structure.

A rivet head can be formed to capture multiple injection material laminations using a simple core-cavity tool.

An undercut features can be added to appropriate locations without lifters or slides. Typically, to make undercut features, some space is required so that lifters and sliders can move along the space. This novel method does even not require any lifters or sliders to create the undercut features. Therefore, the anti-delamination feature and process for producing double injection molded parts, provides not only the design space effects but also cost saving.

Polycarbonates (PC) rivet features can be created by tool compression. The undercut feature cannot theoretically be molded with typical lifters. This undercut feature physically prevents two (2) shot material from being delaminated.

In the anti-delamination feature and process for producing double injection molded parts, one or more undercut features can be added to physically prevent delamination between the 1^{st} and 2^{nd} shot. The undercut features get compressed and shaped by closing the 2^{nd} shot core. This provides a permanent solution so that there is practically no chance of delamination when the molded part is used by the user. These undercut features can prevent the delamination between 1^{st} and 2^{nd} shot materials in use. This novel method can also provide designers with chances to achieve the desired molded parts by double injection molding even if the design requirements specify very limited sizes (thicknesses).

A tool can be made with a specially shaped head and/or tip that helps forming undercut features. Different kinds of shapes could be applied. For example, conic, spherical shape, etc.

In the anti-delamination feature and process for producing double injection molded parts, double injection molded parts can be made even with very thin thickness. This means it offers wider design options. For example, external grommet parts for cell phones produced by the inventive anti-delamination process, offer more and better painting or other finishing options such as plating, non-conductive vacuum metallization (MCVM), etc.

The anti-delamination feature and process for producing double injection molded parts can significantly decrease the cost of poor quality (COPQ). This new method provides special features and allows the core side of the tool to slowly heat and split individual posts to create the desired effect. If desired, a more complicated plastic injection tool can be made with side slide features to perform the undercuts.

The effective anti-delamination process for double injected molding, can comprise the steps of: providing a double injection mold; injecting a first shot into the double injection mold; forming an undercut comprising a delamination feature in the double injection mold by tool compression or partial heating; injecting a second shot into the double injection mold; allowing the shots to solidify; forming a double injected molded part; and substantially preventing delamination of the molded part. In the anti-delamination process, the molded part can be injected from the mold and the undercut can be formed without any lifters or sliders. The anti-delamination process is particularly useful for molding USB grommets as well as other molded products.

Each shot can be of a different material, such as a different plastic and/or can be a different color. In the preferred process, the first shot comprises polycarbonate (PC) and the second shot comprises thermal polyurethane (TPU).

In the anti-delamination process, the undercut can be nail-shaped or rivet-shaped. Furthermore, the undercut can be formed by tool compression, such as by compression of a tool having a conical tip, spherical tip, hexagonal tip, convex tip, nail-shaped tip or rivet-shaped tip, and with the undercut having a contour that is shaped complementary to the tip. If desired, the undercut can be formed by partial heating.

The invention can also provide special anti-delamination features for double injected molded parts. This is useful with a double injection mold with a cavity and a mold core comprising a tool with an elongated body and a head providing a tip. The head can have a transverse span which is substantially greater than a maximum transverse distance across the elongated body of the tool. A first shot comprising a first material can be provided for injection into the cavity. Advantageously, an anti-delamination undercut can be formed, such as by compression of said tool after the first shot has been injected into the cavity. A second shot comprising a second material can be provided for injection into the cavity after the anti-delamination undercut is formed. Desirably, the second material is different than the first material. The double injected laminated molded part can be formed by contacting the first and second materials and substantially preventing the first and second material from subsequently separating from each other and delaminating from the first and second materials of the molded part.

In a preferred form, the cavity in the double injection mold, comprises a grommet-shaped cavity so that the molded part comprises a grommet for use in an electronic communications device, such as one or more of the following: a mobile phone, flip phone, portable networking device, internet communications device, camera phone, clamshell device, radio telephone, cellular phone, portable game player, smart phone, portable gaming device, portable media player (PMP), personal digital assistant (PDA), wireless e-mail device, and handheld electronic device.

In the illustrated form, the grommet comprises an external phone grommet with a thickness less than 1 mm. The first material can comprise polycarbonate (PC) and the second material can comprise thermal polyurethane (TPU). The grommet can have a decorated outer surface, such as a decoration comprising a color, white, glitter, plating, paint, a ultraviolet (UV) coating, and/or non-conductive vacuum metallization (NCVM).

The tool used to form the anti-delamination feature for double injected molded parts can comprise a metal vessel with a cylindrical body comprising a pole. The tip of the tool can be a cylindrical tip, conical tip, spherical tip, hexagonal tip, convex tip; rivet-shaped tip, or a nail-shaped tip. The undercut can have a contour that is shaped complementary to the tip of said tool, so as to provide a cylindrical contour, conical contour, spherical contour, hexagonal contour, concave contour, rivet-shaped contour, or a nail-shaped contour.

A more detailed explanation of the invention is provided in the following detailed descriptions and appended claims taken in conjunction with the accompanying drawings.

### BRIEF DESCRIPTION OF THE DRAWINGS

FIG. 1 is a perspective diagrammatic view of anti-delamination feature and process for producing double injection molded parts to prevent delamination in accordance with principles of the present invention.

FIG. 2 is a diagrammatic view of the anti-delamination feature and process for producing double injection molded parts after the 2^{nd} shot.

FIG. 3 is another diagrammatic view of the anti-delamination feature and process for producing double injection molded parts.

FIG. 4 is a diagrammatic view of the anti-delamination feature and process for producing double injection molded parts with partial heated to the undercut feature area.

FIG. 5 is an illustration of actual samples.

FIG. 6 is an illustration of other actual samples.

FIG. 7 illustrates samples and diagrams of two kinds of pole design.

FIG. 8 illustrates a pole design with a larger diameter after it was compressed.

FIG. 9 illustrates cross-sectional views of PC rivet poles for anti-delamination.

FIG. 10 is an enlarged detailed cross-sectional view of Detail A in FIG. 9.

FIG. 11 is a top view of a molded part produced in accordance with the anti-delamination feature and process.

FIG. 12 is a front view of the molded part.

FIG. 13 is a cross-sectional view of the molded part.

FIG. 14 is a side view of the molded part.

FIG. 15 is a back view of the molded part.

FIG. 16 is a front perspective view of the molded part.

FIG. 17 is a back perspective view of the molded part.

FIG. 18 is an interior perspective view of the molded part.

FIG. 19 is a rear perspective view of the molded part.

FIG. 20 is a perspective view of a mold after the 1st shot.

FIG. 21 is a perspective view of the mold after the 2nd shot.

FIG. 22 is a perspective view of a double injection molded grommet in an electronic communications device.

### DETAILED DESCRIPTION OF THE INVENTION

The following is a detailed description and explanation of the preferred embodiments of the invention and best modes for practicing the invention.

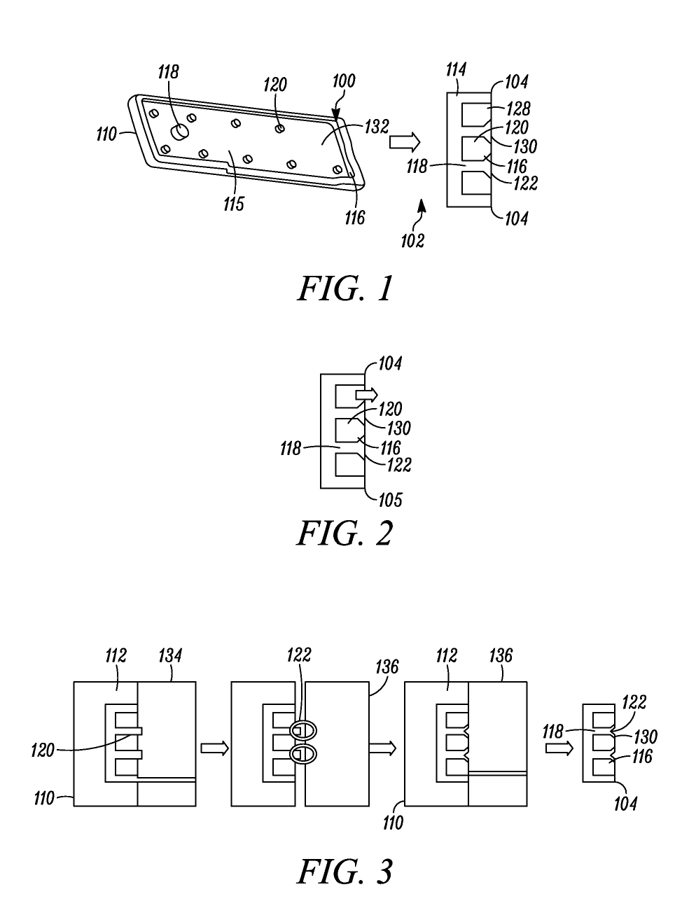

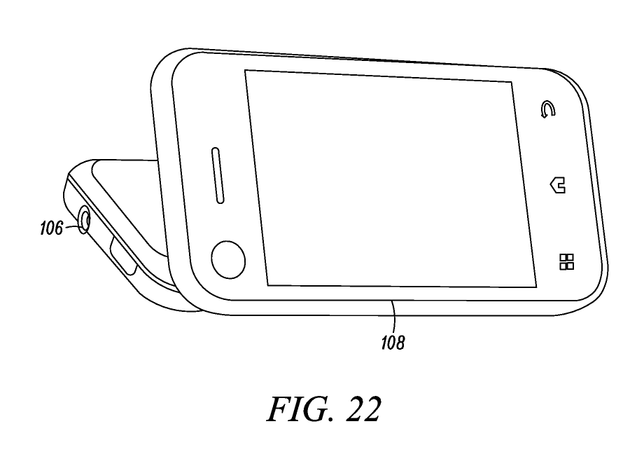

An effective economical anti-delamination feature 100 (FIG. 1) and process 102 or double injected molding is provided to mold attractive high quality products 104. While the anti-delamination process can be useful to mold many types of products, it is particularly useful to mold grommets 106 (FIG. 22) for use in an electronic communications device 108, such as one or more of the following: a mobile phone, flip phone, portable networking device, internet communications device, camera phone, clamshell device, radio telephone, cellular phone, portable game player, smart phone, portable gaming device, portable media player (PMP), personal digital assistant (PDA), wireless e-mail device, and handheld electronic device.

For grommets, the double injection mold 110 (FIGS. 1 and 2) can be provided with a grommet-shaped cavity 112. In the anti-delamination process, a first (1^{st}) shot 114 comprising a first material is injected into the grommet-shaped cavity of the double injection mold. Thereafter, a nail-shaped undercut 116 comprising a delamination undercut feature is formed in the double injected mold by tool compression of a nail-shaped tool 118 of a mold core after the first shot. The nail-shaped tool can have an elongated body 120 and a head 122. The head can have a transverse span 124 (FIG. 21) or diameter which can be substantially greater than a maximum transverse distance 126 or diameter of the elongated body of the nail-shaped tool. Afterwards, a second shot 128 comprising a second material, which can be different than the first material, can be injected into the grommet-shaped cavity of the double injected mold after the nail-shaped undercut feature has been formed. Thereafter, the shots are allowed to solidify and an attractive double injected molded laminated grommet is formed. Advantageously, the anti-delamination process minimizes separation of the first and second materials in the double injected molded grommet and substantially prevents delamination of the grommet.

In the anti-delamination feature and process, the tool can comprise a second shot tool. The first material can comprise a plastic material and the second material can comprise a rubber-like material. The anti-delamination process can also include decorating an outer surface of the molded product by a decorating process, such a non-conductive vacuum metallization (NCVM), painting, spraying, ultraviolet (UV) coating, and/or plating.

In the illustrative embodiment, the grommet can comprise an external USB laminated phone grommet with a thickness less than 1 mm. The first material can comprise polycarbonate (PC) and the second material can comprise thermal polyurethane (TPU). Desirably, in the illustrative anti-delamination process, a PC rivet pole can be formed after the first shot by compressing the PC rivet poles with a clamping force during the second shot.

In the anti-delamination feature and process, the tool can comprise a metal vessel with a cylindrical body comprising a pole 120 (FIG. 1) and a head with a tip 130, such as a cylindrical tip, conical tip, spherical tip, hexagonal tip, convex tip or a rivet-shaped tip. The undercut can have a contour 132 that is complementary to the shape of the tip of the head, such as a cylindrical contour, conical contour, spherical contour, hexagonal contour, concave contour or a rivet-shaped contour.

The invention can also provide special anti-delamination one or more features for double injected molded parts. This can be useful with a double injection mold with a cavity and a mold core comprising a tool with an elongated body and a head providing a tip. As previously indicated, the head can have a transverse span or diameter which is substantially greater than a maximum transverse distance or diameter across the elongated body of the tool. A first shot comprising a first material can be provided for injection into the cavity. Advantageously, an anti-delamination undercut can be formed, such as by compression of the tool after the first shot has been injected into the cavity. A second shot comprising a second material can be provided for injection into the cavity after the anti-delamination undercut is formed. Desirably, the second material is different than the first material. The double injected laminated molded part can be formed by contacting the first and second materials and substantially preventing the first and second material from subsequently separating from each other and delaminating either of the materials from the molded part.

The tool to form the anti-delamination feature for double injected molded parts can comprise a metal vessel with a cylindrical body, such as a pole.

Double injection molding can inject two colors or two different materials in the same mold and process to lower molding costs and attain higher quality more attractive products. Double injection molding or 2-shot molding can combine two plastic materials injected into the mold to form a single part with two visible colors. This process allows for clear windows, colored lettering or graphics and a more decorative and stylish appearance to molded parts. Two-shot molding or double injection molding is a kind of co-injection technique for multi-component molding. It can produce plastic parts with two or more colors molded at the same time. It also can eliminate secondary processes and add logos, graphics or text. Two-shot molding materials should be compatible with each other and/or have interlocking features that will assure a good union of the two resins (materials), such as PC, TPU, ABS with TPE, TPR, etc. Two-shot injection molding can allow the first material to cool before the second material is injected.

As shown in FIGS. 1-2, the undercut features can be added between the 1^{st} and 2^{nd} shots to physically prevent delamination. The undercut features as shown in FIG. 2 can get compressed and shaped by closing the 2^{nd} shot core.

Step 1 of FIG. 3 illustrates the 1^{st} shot injection in the cavity of the double injection mold. The 1^{st} shot core 134 is then removed and switched to the 2^{nd} shot core 136 as illustrated in Step 2 of FIG. 3. The 1^{st} shot poles are compressed as the 2^{nd} shot core closes. Step 3 of FIG. 3 illustrates the 2^{nd} shot injection. Step 4 of FIG. 3 illustrates the part release.

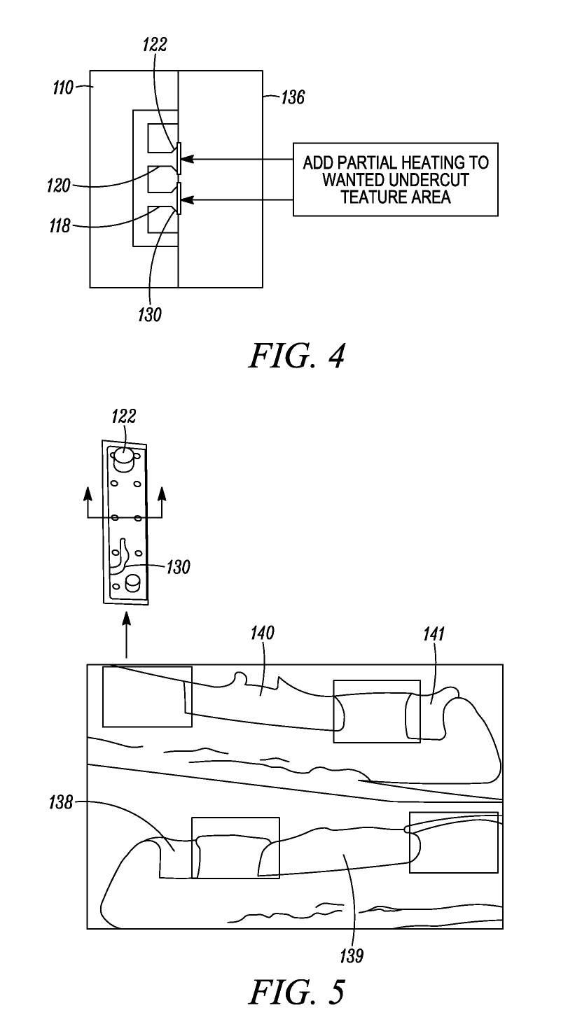

FIG. 4 illustrates partial heating added to the wanted undercut feature area.

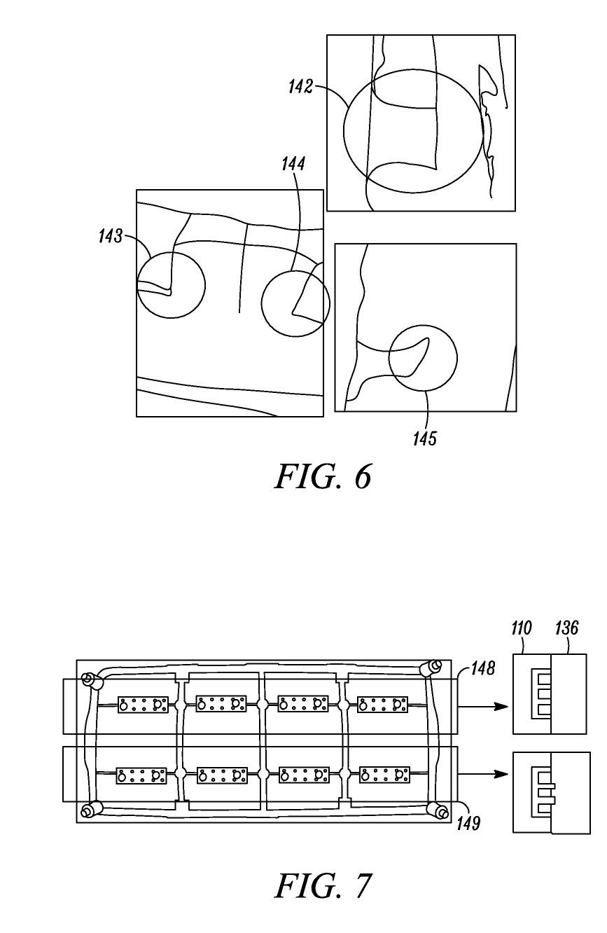

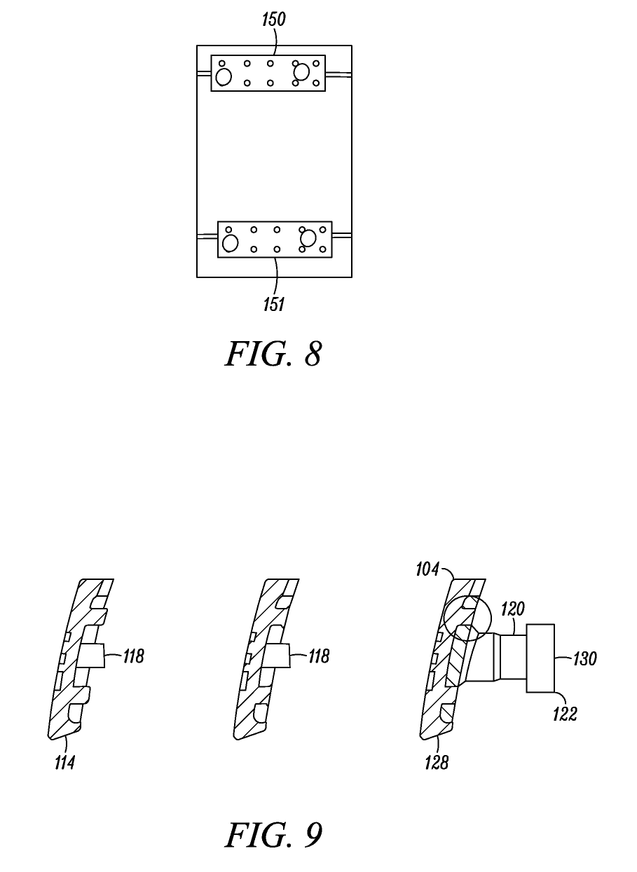

FIGS. 5-8 illustrate actual samples 138-151. In the ideal case, the pole can be compressed to be rivet shape. Sometimes, buckling occurs upon compression of the tool, but it still can produce an effective undercut. FIGS. 7 and 8 illustrates two different pole designs. The pole diameter is bigger in FIG. 8 because it is compressed.

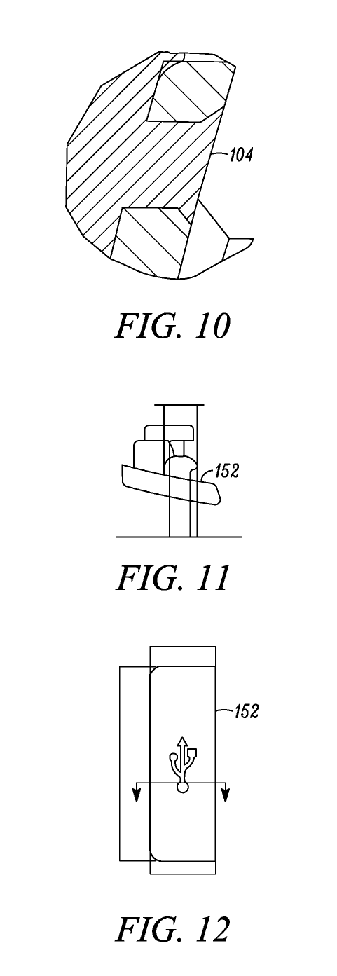

FIG. 9 illustrates the steps for producing PC rivet poles for anti-delamination. The first step, shown on the left, is after the 1^{st} PC shot. The second step, shown in the middle, is after closing the 2^{nd} shot tool. The third step, shown on the right, is after the 2^{nd} shot injection of TPU. FIG. 10 illustrates an enlargement of Detail A of FIG. 9 in which the PC poles are compressed to a rivet shape by a clamping force at the 2^{nd} shot. Undercuts are formed by compression to prevent delamination between the PC of the 1^{st} material and the TPU of the 2^{nd} material.

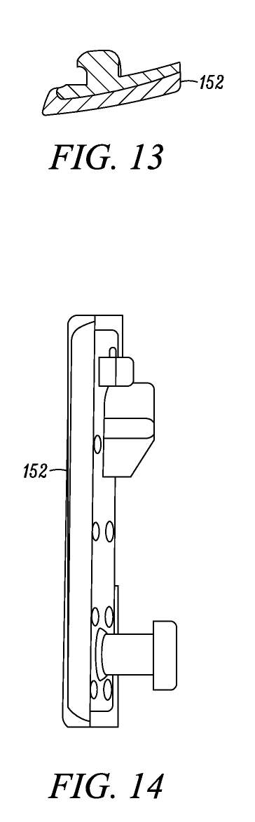

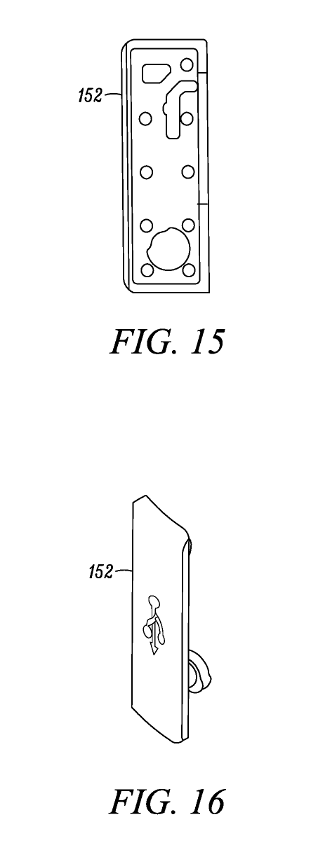

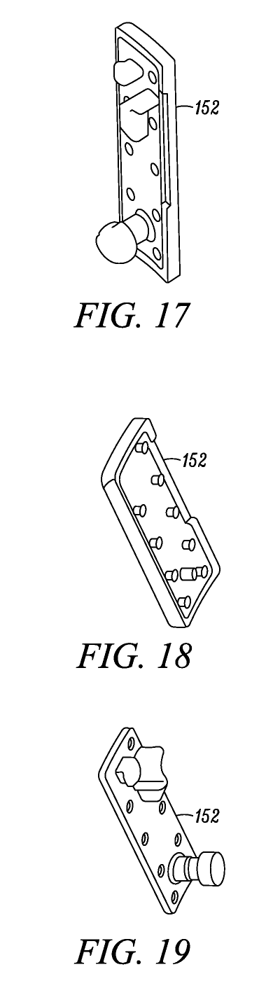

FIGS. 11-19 illustrate other double injection molded parts 152 produced with the inventive anti-delamination features and process. Some masking may be useful.

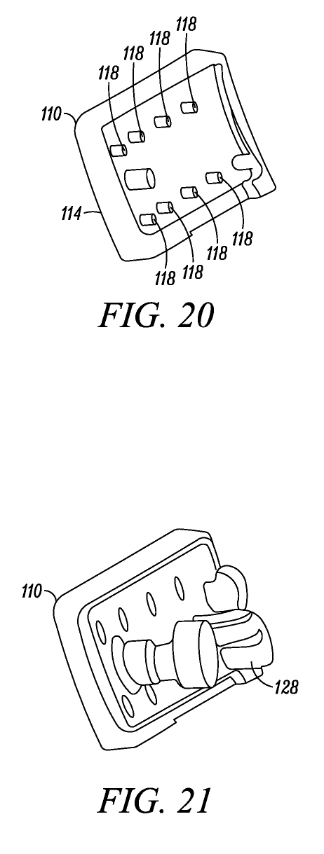

FIG. 20 illustrates a number of poles in the 1^{st} shot, which are located proud from the part line, between the 1^{st} and 2^{nd} shots. How much proud from the parting, can be determined considering the design of the molded part. As shown in FIG. 21, the pole can be compressed and shaped like rivets. The undercut features are formed by a tool clamping force right before the 2^{nd} shot injection.

FIG. 22 is a perspective view of a double injection molded grommet in an electronic communications device. The double injected molded grommet can be produced in accorded with the anti-delamination feature and process of this invention.

Among the many advantages of the anti-delamination features and process for double injected molding are:

1. Superior prevention of delamination of double injected molded parts.

2. Superb capabilities for double injection molding.

3. Enhanced molded parts.

4. Excellent quality.

5. Better wear.

6. Outstanding performance.

7. Reliable.

8. User friendly.

9. Easy to use.

10. Durable.

11. Economical.

12. Attractive.

13. Efficient.

14. Effective.

Although embodiments of the invention have been shown and described, it is to be understood that various modifications, substitutions, and rearrangements of parts, components, and/or process (method) steps, as well as other uses of the delamination feature and process, can be made by those skilled in the art without departing from the novel spirit and scope of this invention.

What is claimed is:

1. An anti-delamination process for double injected molding, comprising the steps of:
providing a double injection mold;
injecting a first shot into the double injection mold;
forming an undercut comprising a delamination feature in the double injection mold by tool compression or partial heating;
injecting a second shot into the double injection mold;
allowing the shots to solidify;
forming a double injected molded part; and
substantially preventing delamination of the molded part.

2. An anti-delamination process in accordance with claim 1 wherein:
the molded part is ejected from the mold; and
the undercut is formed without lifters or sliders.

3. An anti-delamination process in accordance with claim 1 wherein each shot is a different material.

4. An anti-delamination process in accordance with claim 1 wherein each shot is a different plastic.

5. An anti-delamination process in accordance with claim 1 wherein the first shot comprises polycarbonate (PC).

6. An anti-delamination process in accordance with claim 1 wherein the second shot comprises thermal polyurethane (TPU).

7. An anti-delamination process in accordance with claim 1 wherein the molded part comprises a grommet.

8. An anti-delamination process in accordance with claim 1 wherein:
the undercut is nail-shaped or rivet-shaped; and
the undercut is formed by tool compression.

9. An anti-delamination process in accordance with claim 1 wherein:
the undercut is formed by compression of a tool having a tip selected from the group consisting of a cylindrical tip, conical tip, spherical tip, hexagonal tip, convex tip, nail-shaped tip and a rivet-shaped tip; and
the undercut has a contour that is shaped complementary to the tip.

10. An anti-delamination process in accordance with claim 1 wherein the undercut is formed by partial heating.

11. An anti-delamination feature for double injected molded parts, comprising:
a double injection mold with a cavity;
a mold core comprising a tool with an elongated body and a head providing a tip, said head having a transverse span substantially greater than a maximum transverse distance across said elongated body of said tool;
a first shot comprising a first material for injection into said cavity;
an anti-delamination undercut formed by compression of said tool after said first shot has been injected into said cavity;
a second shot comprising a second material for injection into said cavity after said antidelamination undercut is formed, said second material being different than said first material; and
a double injected laminated molded part comprising said first and second materials substantially contacting each other and being substantially prevented from separating and delaminating.

12. An anti-delamination feature for double injected molded part in accordance with claim 11 wherein:
said cavity comprises a grommet-shaped cavity;
said molded part comprises a grommet for use in an electronic communications device selected from the group consisting of a mobile phone, flip phone, portable networking device, internet communications device, camera phone, clamshell device, radio telephone, cellular phone, portable game player, smart phone, portable gaming device, portable media player (PMP), personal digital assistant (PDA), wireless e-mail device, handheld electronic device and combinations thereof.

13. An anti-delamination feature for double injected molded part in accordance with claim 12 wherein:
said grommet comprises an external phone grommet with a thickness less than 1 mm;
said first material comprises polycarbonate (PC);
said second material comprise thermal polyurethane (TPU); and
said grommet comprises a decorated outer surface comprising a decoration selected from the group consisting of color, white, glitter, plating, paint, ultraviolet (UV) coating, and non-conductive vacuum metallization (NCVM).

14. An anti-delamination feature for double injected molded part in accordance with claim 11 wherein:
said tool comprises a metal vessel with a cylindrical body comprising a pole;
said tip of said tool is selected from the group consisting of a cylindrical tip, conical tip, spherical tip, hexagonal tip, convex tip; rivet-shaped tip, and a nail-shaped tip; and
said undercut has a contour shaped complementary to said tip of said tool and said contour of said undercut is selected from the group consisting of a cylindrical contour, conical contour, spherical contour, hexagonal contour, concave contour, rivet-shaped contour and a nail-shaped contour.

15. An anti-delamination process for double injected molding, comprising the steps of:
providing a double injection mold with a grommet-shaped cavity;
injecting a first shot comprising a first material into the grommet-shaped cavity of the double injection mold;
forming a nail-shaped undercut comprising a delamination undercut feature in the double injected mold by tool compression of a nail-shaped tool of a mold core after the first shot, the nail-shaped tool having an elongated body and a head, the head having a transverse span substantially greater than a maximum transverse distance across the elongated body of the nail-shaped tool;
injecting a second shot comprising a second material into the grommet-shaped cavity of the double injected mold after the nail-shaped undercut feature has been formed, the second material being different than the first material;
allowing the shots to solidify;
forming a double injected molded laminated grommet; and
substantially minimizing separation of the first and second materials in the double injected molded grommet to substantially prevent delamination of the grommet.

16. An anti-delamination process in accordance with claim 15 wherein the grommet is used in an electronic communications device selected from the group consisting of. a mobile phone, flip phone, portable networking device, internet communications device, camera phone, clamshell device, radio telephone, cellular phone, portable game player, smart phone, portable gaming device, portable media player (PMP), personal digital assistant (PDA), wireless e-mail device, handheld electronic device and combinations thereof.

17. An anti-delamination process in accordance with claim 15 wherein the grommet comprises an external phone grommet with a thickness less than 1 mm.

18. An anti-delamination process in accordance with claim 15 wherein:
the tool comprises a second shot tool;
the first material comprises a plastic material;
the second material comprises a rubber-like material;
the anti-delamination process includes decorating an outer surface by a decorating process selected from the group consisting of non-conductive vacuum metallization (NCVM), painting, spraying, ultraviolet (UV) coating, and plating.

19. An anti-delamination process in accordance with claim 15 wherein:
the first material comprises polycarbonate (PC); and
the second material comprises thermal polyurethane (TPU); and
the anti-delamination process includes forming a PC rivet pole after the first shot by compressing the PC rivet poles with a clamping force during the second shot.

20. An anti-delamination process in accordance with claim 15 wherein:
the tool comprises a metal vessel with a cylindrical body comprising a pole and a head comprising a tip selected from the group consisting of a cylindrical tip, conical tip, spherical tip, hexagonal tip, convex tip and a rivet-shaped tip; and
the undercut has a contour that is complementary to the shape of the tip, the contour being selected from the group consisting of a cylindrical contour, conical contour, spherical contour, hexagonal contour, concave contour and a rivet-shaped contour.
